(19) United States
(12) Patent Application Publication
(10) Pub. No.: US 2023/0405842 A1
(43) Pub. Date: Dec. 21, 2023

(54) A GRIPPING DEVICE

(71) Applicants: National University of Singapore, Singapore (SG); Agency for Science, Technology and Research, Singapore (SG)

(72) Inventors: Phone May KHIN, Singapore (SG); Jin Huat LOW, Singapore (SG); Chao-Yu CHEN, Singapore (SG); Chen Hua YEOW, Singapore (SG); Ying ZHANG, Singapore (SG)

(21) Appl. No.: 18/251,877

(22) PCT Filed: Nov. 3, 2021
(86) PCT No.: PCT/SG2021/050666

§ 371 Date: May 4, 2023

(30) Foreign Application Priority Data
Nov. 4, 2020 (SG) 10202010966W

(51) Int. Cl. B25J 15/12; B25J 15/10; B25J 15/06

(52) U.S. Cl. CPC B25J 15/12; B25J 15/103; B25J 15/0616

(57) ABSTRACT

A gripping device comprising: a base; at least one pair of extendable linkages connected at a proximal end to the base; each extendable linkage having a gripping finger extending from a distal end of the extendable linkage; wherein the extendable linkages are arranged to extend or retract from the base so as to increase a radial distance between the gripping fingers.

### FIELD OF INVENTION

The present invention relates to a gripping device and a method for gripping an object, and in particular, the gripping device is used to pick up objects of different shapes and dimensions.

### BACKGROUND

Gripping devices are used to grab different objects of different dimensions and size. However, the gripping devices are usually designed to grab an object within the range of the gripping space of the gripper. When the width of the object is bigger than the gripping space of the gripping devices, the gripping devices may require additional component to attach to the gripping device, which may include a suction, or fingers having bigger width for proper gripping operation. In addition, the conventional gripping devices are not optimized to handle objects from highly inaccessible region, such as corner of a tote bin. Conventional gripping devices also operate on unimodal gripping mode whereby either suction gripping or finger gripping is used to grip an object. Such mono gripping mode is insufficient to mitigate slippage of packages during high-speed transportation due to irregular deformation of package material and shifting of centre of gravity of powder content within the package. In such scenarios, suction gripping of packages which are supported by finger gripping, would be needed to minimise slippage of objects during transportation.

The present invention seeks to ameliorate the above problem.

### SUMMARY OF INVENTION

In a first aspect, the invention provides a gripping device comprising: a base; at least one pair of extendable linkages connected at a proximal end to the base; each extendable linkage having a gripping finger extending from a distal end of the extendable linkage; wherein the extendable linkages are arranged to extend or retract from the base so as to increase a radial distance between the gripping fingers; one extendable palm structure with a suction cup; wherein the extendable palm structure are designed to extend or retract vertically from the base so as to increase the accessibility of the gripper.

In a second aspect, the invention provides a method of gripping an object, the method comprising the steps of: positioning and aligning the gripping device; extending or retracting the extendable linkage, extending or retracting the extendable palm structure and; moving the at least pair of gripping fingers relative to the base

Accordingly, it is an objective of the present invention to provide a gripping device having variable grasp modes that can be remotely achieved by regulating the embedded motors and solenoid valves in the control system. This eliminates the need to manually alter the gripping device hardware to achieve different grasp configurations.

The present invention provides a variable grasp mode that can be remotely achieved by regulating the embedded motors and solenoid valves in the control system. This eliminates the need to manually alter the gripping device hardware to achieve different grasp configurations.

In one embodiment, the gripping device may include vacuum suction cups that may enable the gripping device to pick up items that typically could not be picked using soft fingers. Such items could be of flat or slender form, or could be packaged in smooth plastic materials which make it difficult for the soft fingers to successful grasp them. The suction cups may further increase the weight carrying capacity of the griping device.

The ability to control the extension and retraction of the linkages using an embedded microcontroller may promote the agility of the gripping device to grasp objects of diverse range of sizes and shapes on the fly.

A gripping device comprising a base having a motor, an extendable linkage arranged to connect to the base, at least a pair of gripping fingers arranged to connect to a distal end of the extendable linkage, wherein the motor is configured to extend or retract the extendable linkage. The effective grasping space of the gripping device can be remotely adjusted by controlling the expansion and retraction of four rigid linkages of the base. The four linkages, each of which are connected to four soft fingers, may be simultaneously, pairwise or individually extended so as to increase the distance between said fingers. The greater the distance between the fingers, the larger the object may be grasped. It will be appreciated that the gripping device may operate with a number of gripping fingers arranged circumferentially about the base. To this end, the gripping device may have a single pair of gripping fingers, or in an alternative arrangement, four gripping fingers arranged about the base to provide a stable grip of the object.

Programmable extendibility of the base may enhance the diverse range of items that can be grasped. It may allow the gripping device to grasp large items (such as large biscuit box) and also, small items (such as a small piece of chocolate). Furthermore, remote controlled adjustment of the base width may eliminate the need to manually reconfigure the hardware before the gripping device can grasp different items, which is a conventional technique adopted in the industry. Hence, the extendable base significantly may reduce the need for human intervention and the associated downtime required for reconfiguration of the gripping device and enhance the agility of the pick-and-place process.

Further, the actuator may have at least one suction pads. An extensible soft actuator at the palm with vacuum suction head may provide additional weight bearing function to the fingers of the gripping device. Moreover, by approaching the target item with extended suction head may assure the security of an item within the grasping space before the item is grasped and lifted. In addition, this feature may be useful in scenarios where the gripping device needs to pick selective items in cluttered environment.

Further, a servo motor may be arranged to connect to the base of the at least one pair of gripping fingers, moving the at least one pair of gripping fingers from a retracted position to an extended position. Prior to approaching the target object, the extension of fingers widens the effective grasping scope of the gripping device to cover the peripheral features of the object. This allows the gripping device to securely grasp large items or odd shaped items. Flexion of the fingers allows the gripping device to secure objects via power grasping. Extension of the gripping device also allows the gripping device to hook onto items should they have substantial protrusions.

Further, the at least one pair of gripping fingers is configured to rotate about a rotational axis of the servo motor. This allows the fingers to be rotated along the mounted axis using servo motors and the user to tune the orientation of the fingers and adjust the grasp pose to suit the shape and dimension of the target item.

Further, an anti-slip soft skin may be integrated with the gripping fingers. The palmar surface of the fingers may be integrated with a layer of silicone skin which creates a soft, compliant interface between the fingers and the target object. The silicone skin may also increase the friction coefficient and hence, improve the grasp stability of the gripping device.

Further, the at least one pair of gripping fingers may be embedded with flexible tactile sensors. Thin strips of flexible tactile sensors may be integrated in the palmar surface of the fingers. Force readings from the embedded sensors may enable implementation of closed-loop force feedback control.

Further, the at least one pair of gripping fingers may have at least one magnetic components. The surface of the extensible palm and soft fingers could be integrated with magnetic components in place of suction cup modules. This would allow the gripping device to handle ferromagnetic work pieces.

### BRIEF DESCRIPTION OF DRAWINGS

The above features of the present invention will be described below in more detail based on preferred embodiments of the present invention with reference to the accompanying drawings, in which:

FIGS. 1a to 1d show a gripping device according to an embodiment of the present invention. FIG. 1a is a 3-dimensional view showing a gripping device. FIG. 1B is 3-dimension view of gripping device with direction of movement of rigid linkages (red arrows) and direction of movement of palm extension actuator (blue arrow). FIG. 1c is a 2-dimensional view of gripping device, locations of suction cups are indicated in red dotted circles and FIG. 1d shows a 2-dimensional view of gripping device with cross-sectional view of fingers.

FIGS. 2a to 2d show 2-dimensional view of two different finger orientations according to an embodiment of the present invention.

FIGS. 3a to 3d show 2-dimensional view of gripping device with rigid linkages in retracted state according to an embodiment of the present invention.

FIGS. 4a to 4d show 2-dimensional view of gripping device with rigid linkages in extended state according to an embodiment of the present invention.

FIG. 5 shows example movement of gripping device using different grasp poses to pick up an object according to an embodiment of the present invention.

FIGS. 6a to 6d show various views of a gripping device according to an embodiment of the present invention.

FIGS. 7a to 7c show 3-dimensional drawing of hybrid gripping device prototype device according to an embodiment of the present invention.

FIG. 8 shows 3-dimensional drawing of gripping device with rotary extendable linkages and extendable palm structure with embedded helical air tubes.

FIGS. 9A and 9B show 3-dimensional drawings of a gripping device mounted on a robotic arm at different configurations.

### DETAILED DESCRIPTION

The robotic gripping device 100 and 800 may be used as an end effector for a manufacturing 20 process, or other suitable application where the lifting of a unique article is required.

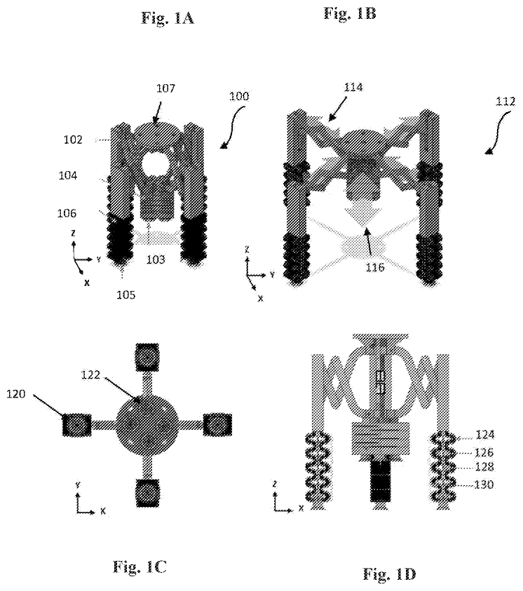

The gripping device comprises two main components: base and fingers 106. The centre of the base houses a motor 711 which drives the extendable linkages 102. FIGS. 1a and 1b show four sets of rigid, retractable linkages that connect the centre of the base to the four fingers 106 of the gripping device. The linkages shown in FIGS. 1a and 1b are planar four-bar linkages, similar to that of a scissor lift. It will be appreciated that other types of linkages may be used, including articulated members in series, parallelogram linkage etc.

The fingers 106 may be soft or rigid. FIG. 1B shows the gripping device in an expansion state 112, where the effective grasping width of the gripping device can be increased or decreased by controlling the expansion and retraction of the rigid linkages 102. As the linkages extend 114, the distance between the fingers increases radially from a zone in which an object may be gripped by the gripping device. The actuator 104 may be arranged to move in vertical direction 116 so as to extend toward, or retract from, the zone. The greater the distance between the fingers, the larger the object may be grasped.

The motor 711 is configured to actuate the extendable linkage such that the extendable linkage is capable of extending or retracting and in response to the extending or retracting, the least a pair of gripping fingers moves relative to the base. This allows the width of at least pair of fingers to change and extend, such that the pair of fingers is able to pick up objects without changing the fingers. FIG. 1c shows that at the centre of the base, one soft extension actuator 104 is implemented in the palmar region of the gripping device. Array of suction pads (two by two) 103 may be embedded at the free end of the actuator at about a centre of the base 107. FIG. 1d shows that the fingers are fabricated with two pneumatic channels and a strain limiting layer 128, the pneumatic channels comprising of a flexion actuation channel 124 and an extension actuation channel 126 which allows bidirectional movement of the finger 106. Further, FIGS. 1c and 1d shows that vacuum suction pads 105 are embedded at the tip of each soft finger 120 on a gripping surface of said finger. A sleeve 130 may be integrated on the fingers, so as to provide addition traction when picking up the object. Further, FIG. 1d shows that the sleeve 130 is placed on the palmar surface of each finger. The sleeve 130 may be an anti-slip soft skin or a silicon soft skin which has frictional resistance so as to provide traction. In some embodiment the device may have a base, at least one pair of extendable linkages connected at a proximal end to the base, each extendable linkage having a gripping finger extending from a distal end of the extendable linkage, and wherein the extendable linkages are arranged to extend or retract from the base so as to increase the radial distance between the gripping fingers.

In an alternative embodiment, the gripping device may have at least a pair of fingers, or an odd number of fingers.

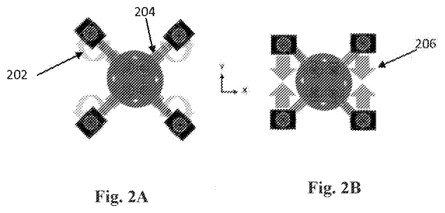

FIGS. 2a and 2b shows that fingers are mounted at the end of each set of linkages. Each of the finger holder houses a small servo motor which is connected to the base of the finger. The servo motor can be controlled to adjust the rotation of the finger. There will be four servo motors for four fingers. By remotely regulating the servo motors, grasp pose of the fingers can be controlled. Red arrows 204, 206 indicate the directions that the finger actuators are facing and the blue arrows 202 indicate the rotation direction of fingers to achieve the pose in FIG. 2b.

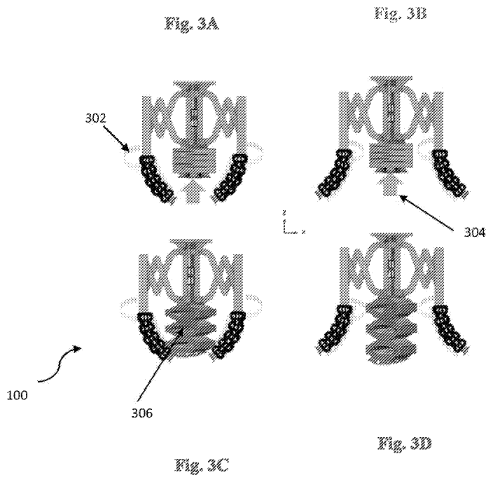

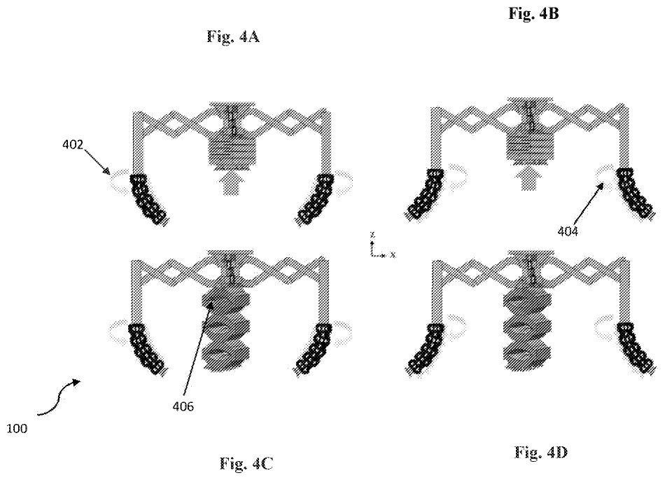

FIGS. 3 and 4 shows that the variable grasp configurations can be achieved by selectively activating and controlling the individual components of the gripping device. FIG. 3 shows direction of movement of finger actuators (yellow arrows 302) and palm extension actuator (red arrow 304, 306). FIG. 3a shows fingers flexed and palm actuator retracted. FIG. 3b fingers extended and palm actuator retracted, FIG. 3c shows fingers flexed and palm actuator extended, FIG. 3d shows fingers extended and palm actuator extended. FIG. 4d shows an embodiment to approach and pick up an object, the palm soft actuator may be extended and the rigid linkages are extended. FIG. 4b shows that upon contact, vacuum pressure is applied on the suction pads which adhere to the target object. Subsequently, secondary vacuum pressure is applied to extension actuator to initiate retraction of the palm actuator. FIG. 3a shows that the centre motor 711 is used to retract the rigid linkages 102 and the fingers of the gripping device flex, therefore lifting the target object. Direction of movement of finger actuators (yellow arrows 402, 404) and palm extension actuator (red arrow 406). FIG. 4a shows fingers flexed and palm actuator retracted, FIG. 4b shows fingers extended and palm actuator retracted, FIG. 4b shows fingers flexed and palm actuator extended, FIG. 4d shows fingers extended and palm actuator extended.

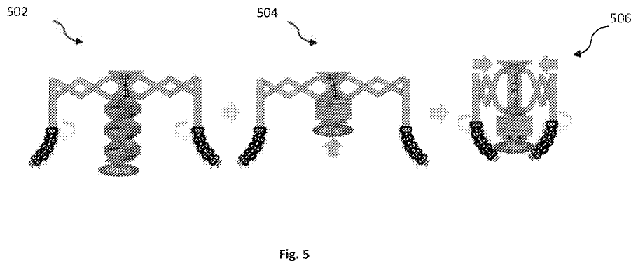

FIG. 5 shows one of the many possible combination 502, 504, 506 of gripping device's grasp poses to pick up an item. Red arrows indicate the movement of palm extension actuator and retraction of rigid linkages according to an embodiment of the present invention. Yellow arrows indicate the flexion and extension motion of the finger actuators. Green arrows indicate subsequent progression of gripping device's grasp poses to pick up the item.

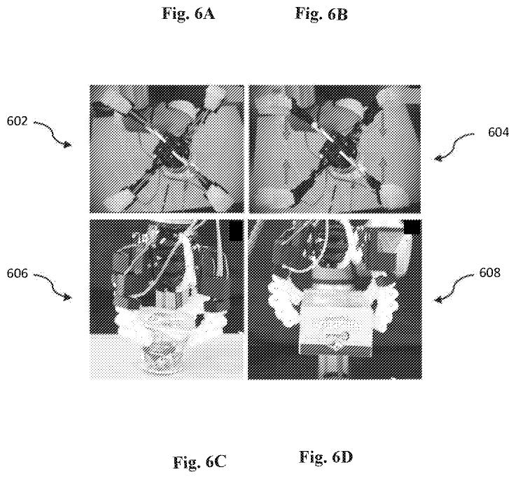

FIG. 6 displays a prototype of the gripping device which was developed using single channel finger actuators. FIG. 6a shows two different orientations of the fingers. As the ideal grasp pose of the gripping device differs based on the shape and dimension of target object, different orientations will be used to grasp different types of objects. For instance, a smaller cylindrical object will require grasp pose displayed in FIG. 6a and a large rectangular box will require grasp pose in FIG. 6b. FIGS. 6a to 6b shows various views of gripping device prototype with single channel fingers, 602, 604. FIGS. 6c to 6d shows Top view of gripping device with different finger orientations 606, 608, Gripping device using different finger orientations to grasp objects of different shapes and sizes.

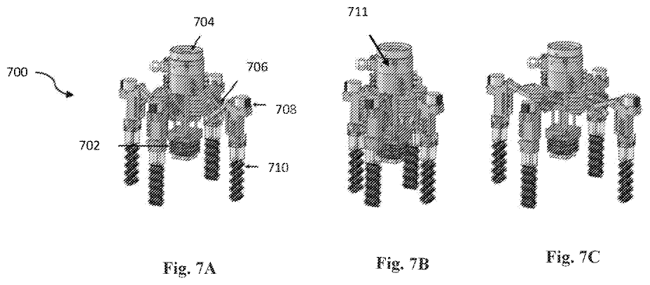

FIG. 7 shows the completed 3d drawing of the hybrid gripping device with peripherals in its retracted state as shown in FIG. 7b and extended state as shown in FIG. 7c. In an alternative embodiment, thin forms of magnets could be implemented in the fingers 710 and palm actuator 702, in place of the vacuum suction cups. This could be applicable to pick-and-place tasks with items of metallic nature. FIG. 7a shows a labelled diagram, where the prototype device having a rotatable finger base 708 such that the rotatable finger base allows the fingers 710 to rotate about an axis of the rotatable finger base 708. The fingers 710 may be moved so to provide more traction with an object, such that the tip of the fingers are in direct contact with the object. This allows the device to pick up objects with irregular shapes, such as a polygon having five or more sides of varying lengths. Further, the device may have soft bidirectional finger, so that the finger moved from a neutral position to a flexion position or an extension position. FIG. 7b shows a gripping device with retracted linkages 706, where the fingers are in a retracted position, FIG. 7c shows a gripping device with extended linkages 706, where the fingers are in an extended position.

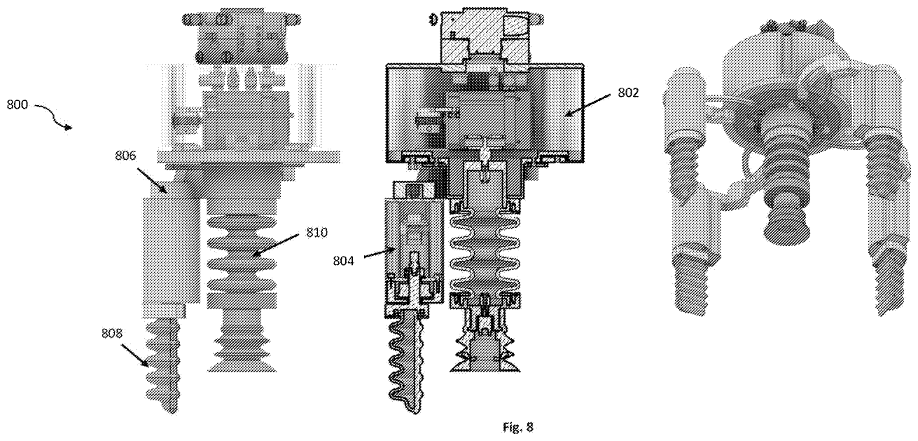

FIG. 8 shows another design of the gripping device with rotary expandable linkages, whereby the fingers 808 are extended relative to the base 802 through rotation. In one embodiment, the rotary expandable linkages are arranged to rotate from within the base, such that in the unextended position the linkages form a compact arrangement with the base. In a further embodiment, in the unextended position, a peripheral surface of the extendable linkages is flush with a body of the base. It comprises two main components: base 802 and fingers 804. The centre of the base houses a motor which drives the rotary extendable linkages 806. It has four sets of rigid rotary linkages that connect the centre of the base to the four fingers 808 of the gripping device. The casted extendable palm actuator 810 allows a custom-made helical air tubes to be embedded in the structure. It ensures the extension and retraction to be performed effectively without any external air tubes.

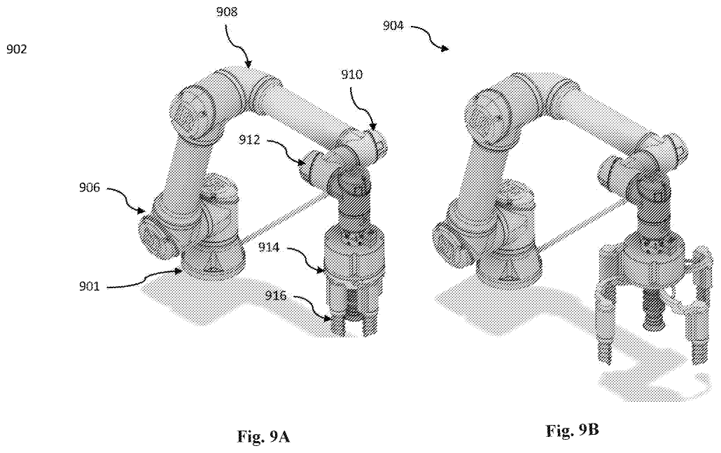

FIGS. 9A and 9B show a gripping device mounted on a robotic arm according to a further embodiment. 902 displays the gripping device in fully contracted stage and 904 displays the gripping device in fully expanded stage. In this embodiment, the base 914 and rotatable extendable linkages 916 have been mounted to robotic arm which comprises a series of members articulated relative to each other. The articulation is in the form of a joint allowing relative rotation between adjacent members. At least two of the rotational joints are positioned such that the axes are rotation are orthogonal to each other. In the embodiment of FIGS. 9A and 9B, there are four such articulated joints 906, 908, 910, 912 which connect four members placed in series from supporting mounting 901 to the base 914, from which the fingers 916 operate. Thus, the arrangement allows for several degrees of freedom to extend and retract the base 914 in a variety of positions through the relative rotation of the articulated joints. It will be appreciated that any of the base units described herein may be used with the series of members described with reference to FIGS. 9A and 9B.

1. A gripping device comprising:
a base;
at least one pair of extendable linkages connected at a proximal end to the base;
each extendable linkage having a gripping finger extending from a distal end of the extendable linkage;
wherein the extendable linkages are arranged to extend or retract from the base so as to increase a radial distance between the gripping fingers.

2. The gripping device according to claim 1, wherein the base further includes an actuator, said actuator having at least one suction pad, wherein the actuator is configured to extend the at least one suction pad towards a zone in which an object is engaged by the gripping device.

3. The gripping device according to claim 1, further including a servo motor, said servo motor arranged to connect to a base of the at least pair of gripping fingers, moving the at least pair of gripping fingers from a flexion position to an extension position.

4. The gripping device according to claim 1, wherein each gripping finger includes at least one vacuum suction pad on a gripping surface of said fingers.

5. The gripping device according to claim 1, wherein the base includes an extensible palm actuator with at least one vacuum suction pad on the free end surface of said palm actuator.

6. The gripping device according to claim 1, wherein the at least pair of gripping fingers having a magnetic component attached thereto.

7. The gripping device according to claim 5, wherein said gripping surface includes an anti-slip soft skin integrated with the gripping fingers.

8. The gripping device according to claim 3, wherein the at least pair of gripping fingers is configured to rotate along a mounted axis of the servo motor.

9. The gripping device according to claim 3, wherein the at least a pair of gripping fingers having embedded with flexible tactile sensors.

10. The gripping device according to claim 1, wherein the extendable linkages include rotary extendable linkages.

11. A method of gripping an object, the method comprising the steps of:
positioning and aligning the gripping device according to claim 1 over the object;
extending or retracting the extendable linkage, and;
moving the at least pair of gripping fingers relative to the base.
